(19) United States
(12) Patent Application Publication
(10) Pub. No.: US 2011/0217516 A1
(43) Pub. Date: Sep. 8, 2011

(54) MULTI-LAYER COATING SYSTEM HAVING A TOP LAYER COMPRISING A TWO-COMPONENT REACTION RESIN

(75) Inventor: Stephan Wedi, Emsdetten (DE)

(73) Assignee: WEDI GMBH, Emsdetten (DE)

(21) Appl. No.: 13/037,881

(22) Filed: Mar. 1, 2011

(30) Foreign Application Priority Data
Mar. 2, 2010 (DE) 10 2010 009 938.4

(51) Int. Cl. E04C 2/24; B32B 27/38; B05D 1/36; B05D 3/02; B05D 1/02; B05D 1/12; B32B 37/02; B32B 37/14

(52) U.S. Cl. 428/150; 427/203; 156/62.2

(57) ABSTRACT

The invention relates to a multi-layer coating system for a body (1) made of a building material, wherein the coating system has a sandwich-like design comprising at least three layers, namely: a first base layer (2) that comes in contact with the body, comprising a fiber-free and granule-free two-component epoxy resin; an intermediate layer comprising a flat random fiber non-woven material (3); and a sand-finished top layer (4) comprising a fiber-free and granule-free two-component epoxy resin. The invention further relates to a method for producing such a coating system.

### BACKGROUND

The invention relates to a multi-layer coating system for a body, said body being a substrate or base for a building material of the coating system, wherein at least one layer of the coating system is a covering layer comprising a two-component reaction resin, which is to say an epoxy resin, which is sand finished with hard granules. The invention further relates to a method for producing the coating system.

The building material comprising the substrate is preferably a polygonal panel. However, other shapes, such as angular pieces, domes, closed hollow bodies and the like shall not be excluded from consideration as bodies to be coated. Two-component reaction resins shall be understood to mean primarily epoxy resins (EP resins), the reaction products of epichlorohydrin and bisphenol A and/or bisphenol F.

However, special resins shall not be excluded from use, such as those based on novolaks, amines, halogenated phenols or cycloaliphatics, which are well known per se.

The length of the molecule chains in the primarily used epoxy resins is dependent on the molar ratio of epichlorohydrin to bisphenol, the coagulation states thereof thus ranging from liquid to solid. It is essential that, to begin with, an application is carried out on the substrate surface in a low-viscosity state, in which the components are tacky-viscous, and the substance is then cured over a curing time into a solid layer.

EP resins have a relatively low water absorption capacity. According to DIN 53472, only 10 mg of water absorption is to be measured for an EP molding compound in the form of granules. Accordingly, an EP resin layer has a water-proof function and vapor-barrier function, depending on the thickness and consistency.

However, it has been shown that admixing fillers and reinforcing materials, which are distributed throughout the EP resins, reduces the vapor-barrier effect. On the other hand, fillers and reinforcement materials, such as glass fibers, for example, are essential elements in terms of increasing the mechanical flexural strength and compression strength. This compression strength is notably required with sand-finished layers. Sand-finishing shall denote, in general, sprinkling with hard, compression-proof granules, such as silica sand, granulated rocks or thermoset materials.

The object of the invention is to provide a coating system for a body to be coated of the type described above, wherein the coating can be adjusted in a quantitatively reproducible manner so that this coating is, and remains, water-proof and vapor-proof, and wherein, to the extent this can be expected in practical experience, the local pressure of the sand-finishing granules is absorbed and does not result in destruction of, or damage to, the coating system. The latter could substantially eliminate the vapor-barrier effect.

This object is achieved by a coating system that has a sandwich-like design comprising at least three layers, namely: a first base layer that comes in contact with the body and comprises a fiber-free and granule-free two-component epoxy resin; an intermediate layer comprising a flat random fiber non-woven material; and a sand-finished top layer, likewise comprising a fiber-free and granule-free two-component epoxy resin.

When using an initially low-viscosity two-component epoxy resin for the reaction mixture, it is possible for the bonding of the layers to each other to be achieved by way of the two-component reaction resin penetrating into the random fiber non-woven material in the low-viscosity state and being cured.

The individual thicknesses the base and top layers preferably range between 0.3 and 5 mm.

The fibers of the random fiber layer are preferably not moisture-sensitive and are selected from the group consisting of glass fibers, polymer fibers, cellulose fibers and/or carbon fibers, including those in the form of hybrid fibers. Hybrid fibers shall be understood to mean those which are composed of a plurality of substances, for example a high-melting polymer at the interior and a polymer that melts at low temperature at the exterior.

When applying the fibers, these are placed so as to produce the random fiber layer from flat fibers forming an unpressed, unbonded web.

The fibers preferably have a length of 1 mm to 20 mm and/or a fiber diameter of between 0.1 mm and 1 mm. The fiber grammage preferably ranges between 10 and 100 g per m² coating surface.

The top layer is preferably coated at the exterior with silica sand having a particle size of 0.125 to 5 mm and/or quartz powder.

When using epoxy resins comprising epichlorohydrin-bisphenol condensates, the average molar ratio of epichlorohydrin to bisphenol A should range between 1.4 and 1.7.

At least one of the epoxy resin layers is preferably cured by cold and/or hot curing.

The coating system can, in particular, be advantageously used on a building material comprising rigid polystyrene foam plastic selected from the group consisting of XPS or EPS foams. To this end, a preferably reinforced mortar layer can be incorporated between the base layer and the rigid polystyrene foam plastic selected as the building material.

It is also possible to repeat the layer sequence in a coating system: at least one further intermediate layer comprising a random fiber non-woven fabric and at least one further top layer are applied onto the layer sequence forming the first sandwich configuration. Sand-finishing, of course, is carried out only once on the outermost layer.

The invention further relates to a method for producing a coated body according to claim 1. To this end, a two-component compound that cures to form an epoxy resin compound is sprayed onto the surface of the body; then fibers are sprinkled, or blown by way of compressed air, onto the layer, which still has low viscosity, so that the fibers bond with the still uncured base epoxy resin layer. Thereafter, the epoxy resin layer is cured by way of cold and/or hot curing. Subsequently, the second two-component epoxy resin compound is applied at a low-viscosity consistency, whereby the layers bond with each other by way of the two-component reaction resin penetrating into the random fiber non-woven fabric in the low-viscosity state and being cured. Lastly, the top layer is sand-finished at the exterior.

The fibers can be applied onto the still uncured epoxy resin layer by way of a dispensing mesh.

The fibers from the supplied fiber rovings are preferably cut and sprinkled immediately before application to the low-viscosity two-component epoxy resin compound.

Another possible way of introducing the fibers is to introduce the random fiber non-woven fabric as an unbonded web layer onto a carrier film, and the carrier film is glued to the base layer. The top layer and the sand-finishing are then applied in the manner described above.

The invention further relates to a coated building board, comprising a substrate that is made of rigid plastic foam having a base layer applied to one side that comprises a cured epoxy resin compound, with which a random fiber layer is bonded, and in which the layers have been bonded to each other by way of the epoxy resin penetrating into the random fibers in the low-viscosity state and being cured to form a top layer, which is provided with a sand-finishing at the exterior.

### BRIEF DESCRIPTION OF THE DRAWINGS

The invention will be explained based on one embodiment in accordance with the figures. The figures show in detail:

FIG. 1 an intermediate product for a building board provided with a coating system;

FIG. 2 the building board provided with a coating system.

### DETAILED DESCRIPTION

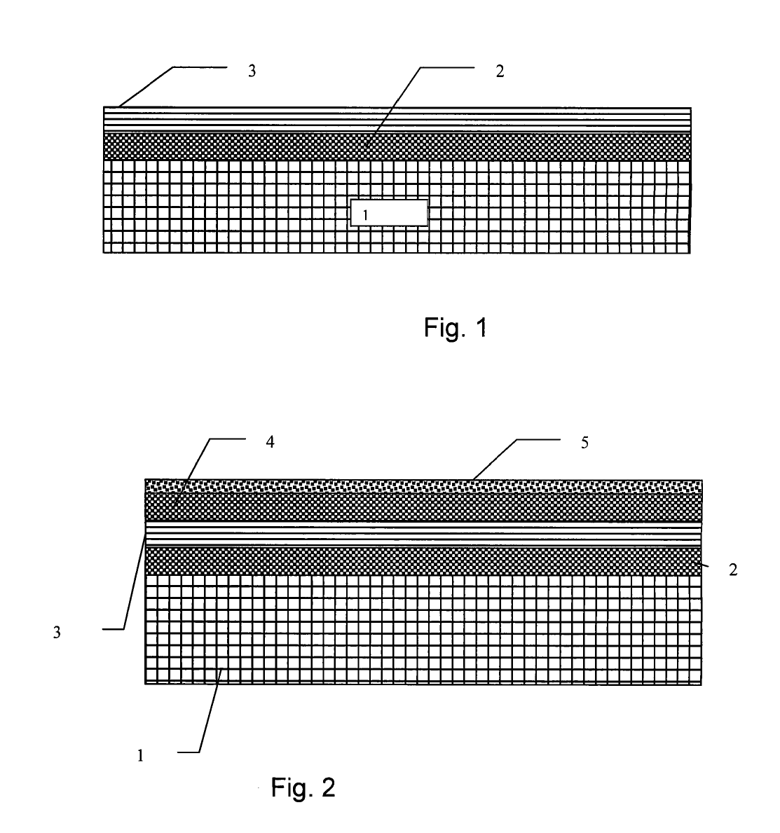

A dimensionally stable XPS foam board 1 having cubic volume is used as the building board, and has a thickness of 80 to 120 mm. The thicknesses of board in proportion to the thicknesses of the coating, as shown in FIGS. 1 and 2, are not true to reality.

In the building board according to FIG. 1, an epoxy resin layer 2 is applied onto the free surface of the board 1 that forms the building material body, by way of spraying. After the spraying process, the thickness of the EP resin layer 2 is between 0.2 and 5 mm, and is leveled to a uniform thickness. Before curing the layer 2, glass fibers are blown onto the surface of the layer 2 by means of compressed air. As a result of pressing and adhesion, the fibers bond with the EP resin layer 2 and lay flat thereon, which is to say no aggregates having raised fibers are formed (“spiked configuration”). The fibers therefore form an unbonded web layer 3 comprising predominantly flat, unpressed fibers, similar to an unbonded web. The glass fibers predominantly have a length of 1 mm to 20 mm. The fiber diameters range between 0.1 and 1 mm. The fiber grammage should range between 10 and 100 g/m² of coating surface.

In place of glass fibers, it is also possible to use, at least in part, polymer fibers, such as PE, PP or polyethylene terephthalate fibers, or even carbon fibers. Cellulose fibers may also be used.

In FIG. 2, the coating is continued. A further EP resin layer 4 is sprayed onto the layer 3 according to FIG. 1. The thickness of the layer 4 is approximately 0.2 to 5 mm. Before final curing, a layer comprising silica sand having a particle size between 0.125 and 5 mm is blown onto this layer 4, so that substantially dense “sand-finishing” is produced, the thickness of which corresponds to the mean thickness of the granular particles, this being approximately 3.5 mm.

Precise adjustments and the selection of the substances to be used with respect to the vapor-barrier capacity are selected empirically, depending on the substrate and desired diffusion-equivalent air layer thickness. It has been shown that easily adjustable reproducibility of the required s_{d} values can be achieved, notably for a diffusion-equivalent air layer thickness s_{d} of ranging between 0.5 and 250 m.

What is claimed is:

1. A multi-layer coating system for a body, said body being a substrate or base for a building material of the coating system, at least one layer of the coating system being a covering layer that comprises a two-component epoxy resin which is sand-finished with hard granules, characterized in that the coating system has a sandwich-like design comprising at least three layers, namely: a first base layer (2) that comes in contact with the body and comprises a fiber-free and granule-free two-component epoxy resin; an intermediate layer that comprises a flat random fiber non-woven material (3), and a sand-finished top layer (4) comprising a fiber-free and granule-free two-component epoxy resin.

2. The coating system according to claim 1, characterized in that bonding of the layers to each other is achieved by way of the two-component epoxy resin penetrating into the random fiber non-woven material (3) in the low-viscosity state and being cured.

3. The coating system according to claim 1, characterized in that the random fiber non-woven material is introduced as an unbonded web layer on a carrier film, and the carrier film is glued to the base layer.

4. A coating system according to claims 1, characterized in that the thicknesses of the base and top layers (2; 4) range between 0.3 and 5 mm, respectively.

5. The coating system according to claim 1, characterized in that the fibers of the random fiber layer (3) are not moisture-sensitive and are selected from the group consisting of glass fibers, polymer fibers, cellulose fibers and/or carbon fibers, including those in the form of hybrid fibers.

6. A coating system according to claim 1, characterized in that the random fiber layer (3) comprises flat fibers forming an unpressed unbonded web.

7. The coating system according to claim 6, characterized in that the fibers have a length of 1 mm to 20 mm and that the fiber diameter ranges between 0.1 mm and 1 mm.

8. The coating system according to claim 1, characterized in that the fiber grammage in the random fiber layer (3) ranges between 10 and 100 g per m² coating surface.

9. The coating system according to claim 1, characterized in that the top layer is coated at the exterior with silica sand having a particle size of 0.125 to 5 mm and/or quartz powder.

10. The coating system according to claim 1, characterized in that, when using epoxy resins comprising epichlorohydrin-bisphenol condensates, the average molar ratio of epichlorohydrin to bisphenol A ranges between 1.4 and 1.7.

11. The coating system according to claim 1, characterized in that the building material for the body (1) to be coated as a substrate is a rigid polystyrene foam plastic selected from the group consisting of XPS or EPS foams.

12. The coating system according to claim 11, characterized in that a preferably reinforced mortar layer is incorporated as a further layer between the base layer and the rigid polystyrene foam plastic selected as the building material.

13. The coating system according to claim 1, characterized in that at least one further intermediate layer comprising a random fiber non-woven material and at least one further top layer are applied onto the layer sequence (2+3+4) forming the first sandwich configuration.

14. A method for producing a coating system on a body, the latter comprising a building material that forms a substrate for the coating system, characterized in that a two-component compound that cures into an epoxy resin compound is sprayed onto the surface of the body, and subsequently fibers are blown onto the layer, which still has low viscosity, by means of compressed air, or are sprinkled thereon, so as to bond with the still uncured epoxy resin layer, whereupon the epoxy resin layer is cured by way of cold and/or hot curing, whereafter a second two-component epoxy resin compound is applied in a low-viscosity state, so that the layers bond to each other by way of the epoxy resin penetrating into the random fibers in the low-viscosity state and being cured, and the top layer is sand-finished at the exterior.

15. The method according to claim 14, characterized in that the fibers are applied onto the still uncured epoxy resin layer by way of a dispensing mesh.

16. The method according to claim 14, characterized in that the fibers from supplied fiber rovings are cut and sprinkled, immediately before application to the low-viscosity two-component epoxy resin compound.

17. A method for producing a coating system according to claim 14, characterized in that a random fiber non-woven material is applied as an unbonded web layer onto a carrier film, a two-component compound that cures into an epoxy resin compound is sprayed onto the surface of the body as the base layer, and the carrier film is glued to the unbonded web on the base layer, whereupon a second two-component epoxy resin compound is applied in a low-viscosity state onto the unbonded web layer as a top layer, and the top layer is sand-finished at the exterior.

18. A coated building board, comprising a substrate (1), which includes rigid plastic foam having a base layer applied to one side thereof that comprises a cured epoxy resin compound bonded to a random fiber layer (3), in which the layers have been bonded to each other by way of the epoxy resin penetrating into the random fiber layer in the low-viscosity state and being cured so as to form a top layer (4), wherein the latter is provided with a sand-finishing (5) at the exterior.
